(19) United States
(12) Patent Application Publication
(10) Pub. No.: US 2026/0017085 A1
(43) Pub. Date: Jan. 15, 2026

(54) AUTOMATICALLY DISCOVERING APPLICATION CANDIDATES

(71) Applicant: ServiceNow, Inc., Santa Clara, CA (US)

(72) Inventors: Robert Bitterfeld, Petah Tikva (IL); Yair Leibkowiz, Kiryat Malachi (IL); Yogev Nisim, Ramat Hasharon (IL)

(21) Appl. No.: 18/767,747

(22) Filed: Jul. 9, 2024

(51) Int. Cl. G06F 9/48

(52) U.S. Cl. CPC G06F 9/48

(57) ABSTRACT

Methods and systems for discovering software applications are disclosed. A plurality of reports corresponding to a plurality of candidate applications is obtained from a plurality of entities, wherein each report comprises information corresponding to a plurality of software processes associated with one of the plurality of candidate applications and running on one of the plurality of entities. Correlations among the plurality of reports corresponding to the plurality of candidate applications from the plurality of entities are identified. A software application classifier for automatically identifying one or more software processes associated with an application that is used across multiple entities is generated based at least in part on the identified correlations. The software application classifier is provided to at least one of the plurality of entities.

### BACKGROUND OF THE INVENTION

A software process is an instance of a computer program that is being executed by electronic circuitry of a computer, such as a central processing unit. The computer program associated with the process is a collection of instructions while the process is the execution of those instructions. Several processes may be associated with the same computer program (also referred to as an application). In fact, in many scenarios, particularly in data center computing environments, there may be tens or hundreds of processes associated with an application. In various scenarios, it is difficult to identify a true application behind the processes, e.g., because process names are often not sufficiently descriptive. Thus, it would be beneficial to develop techniques directed toward improving identification of applications to which processes belong.

### BRIEF DESCRIPTION OF THE DRA WINGS

Various embodiments of the disclosure are disclosed in the following detailed description and the accompanying drawings.

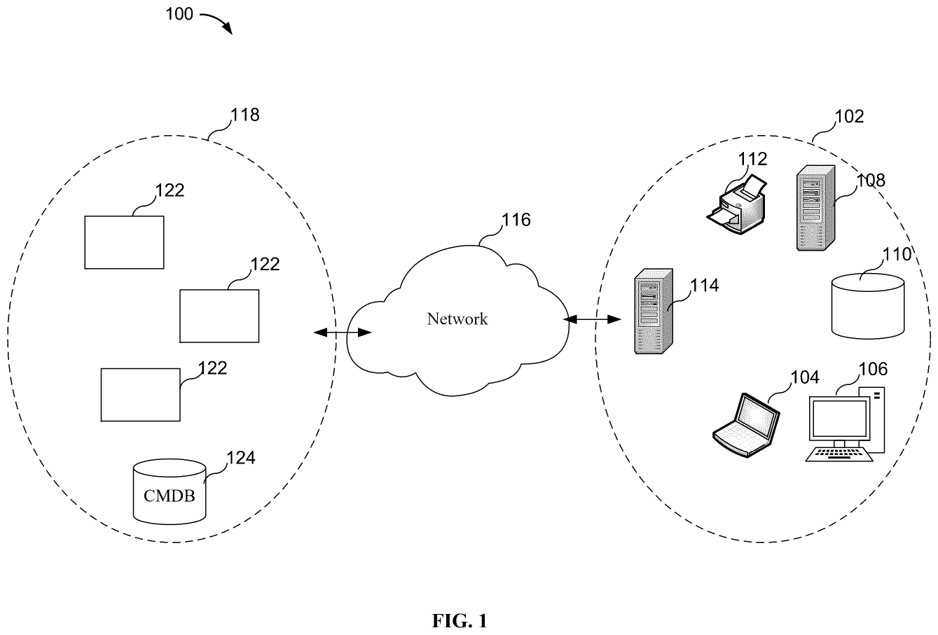

FIG. 1 illustrates an example of an Information technology (IT) operations management (ITOM) system.

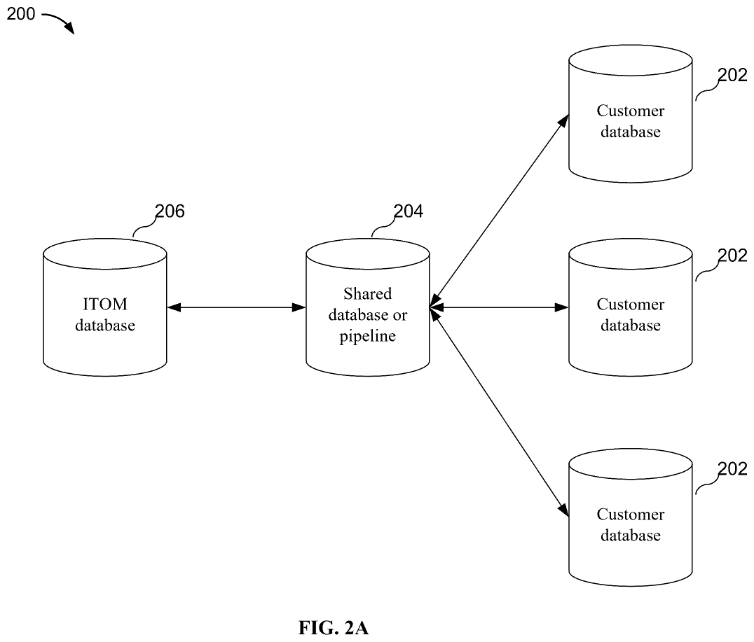

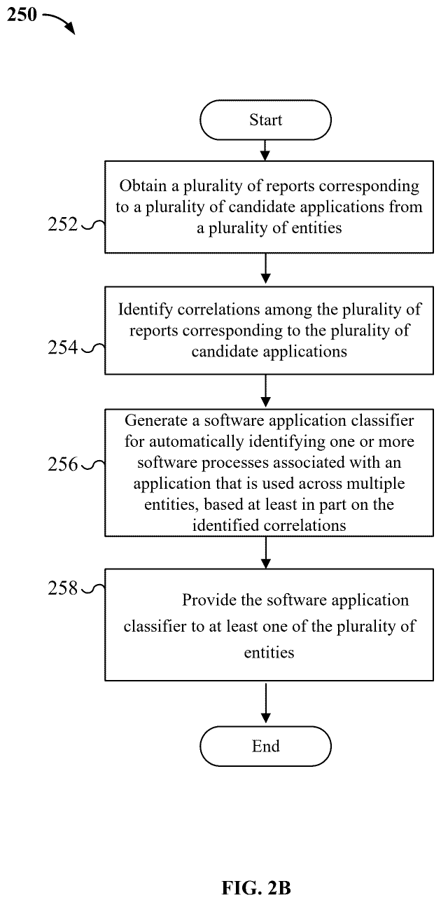

FIG. 2A illustrates an example of a system for identifying running processes associated with a plurality of companies or organizations and classifying them into software process groupings corresponding to different candidate applications.

FIG. 2B illustrates an example of a process for identifying running processes associated with a plurality of companies or organizations and classifying them into software process groupings corresponding to different candidate applications.

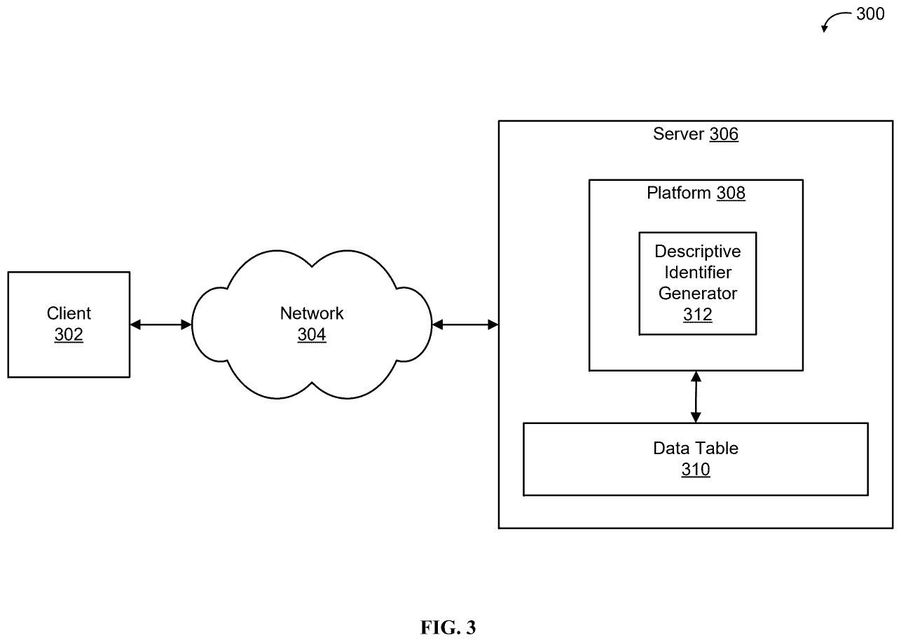

FIG. 3 is a block diagram illustrating an embodiment of a system for determining a descriptive identifier for a software process grouping.

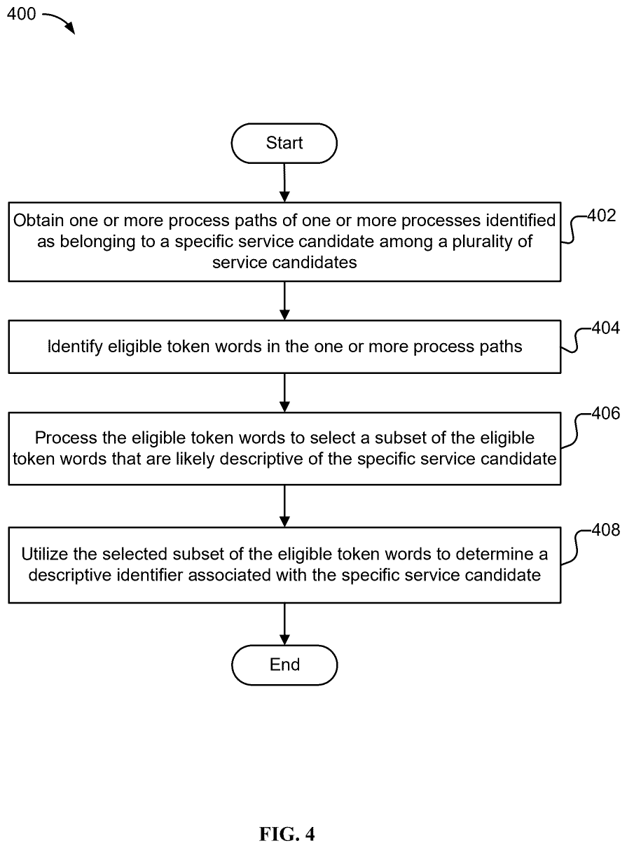

FIG. 4 is a flow chart illustrating an embodiment of a process for determining a descriptive identifier for a software process grouping.

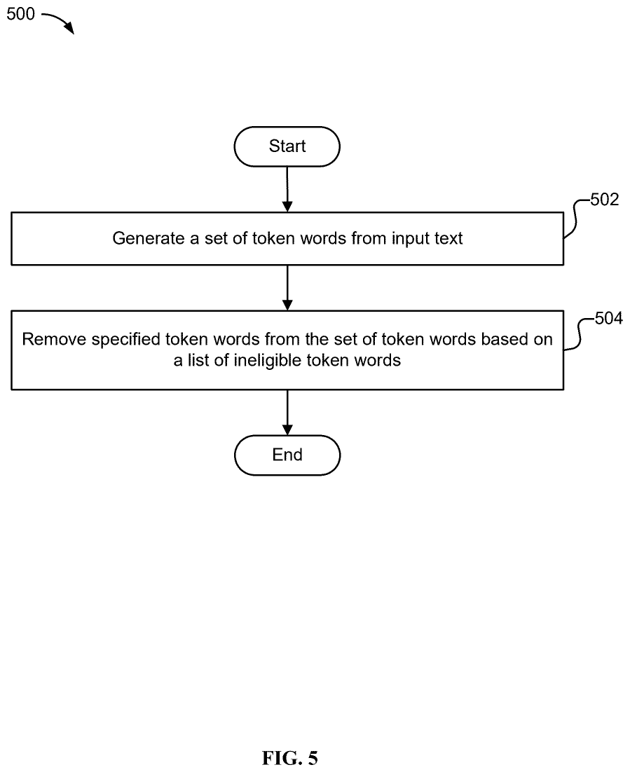

FIG. 5 is a flow chart illustrating an embodiment of a process for identifying eligible token words.

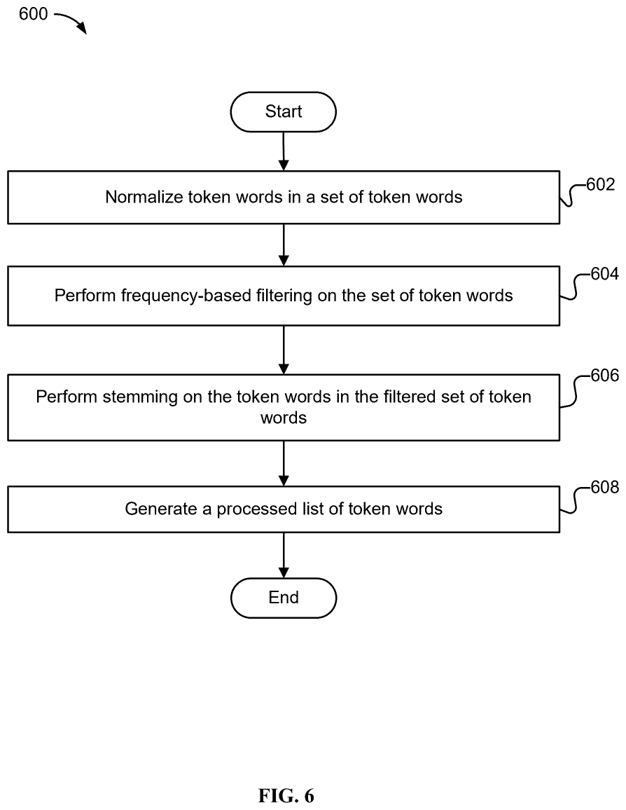

FIG. 6 is a flow chart illustrating an embodiment of a process for processing eligible token words.

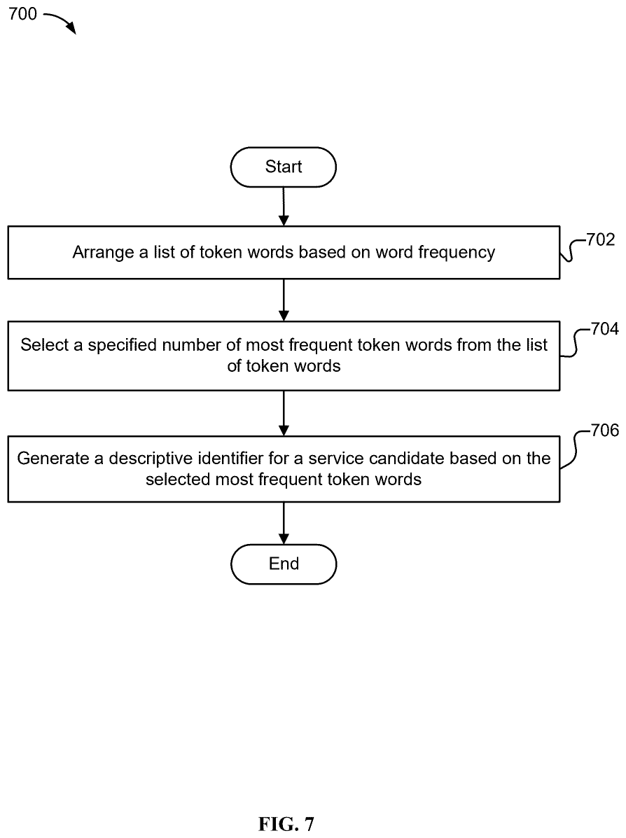

FIG. 7 is a flow chart illustrating an embodiment of a process for utilizing eligible token words to determine a descriptive identifier.

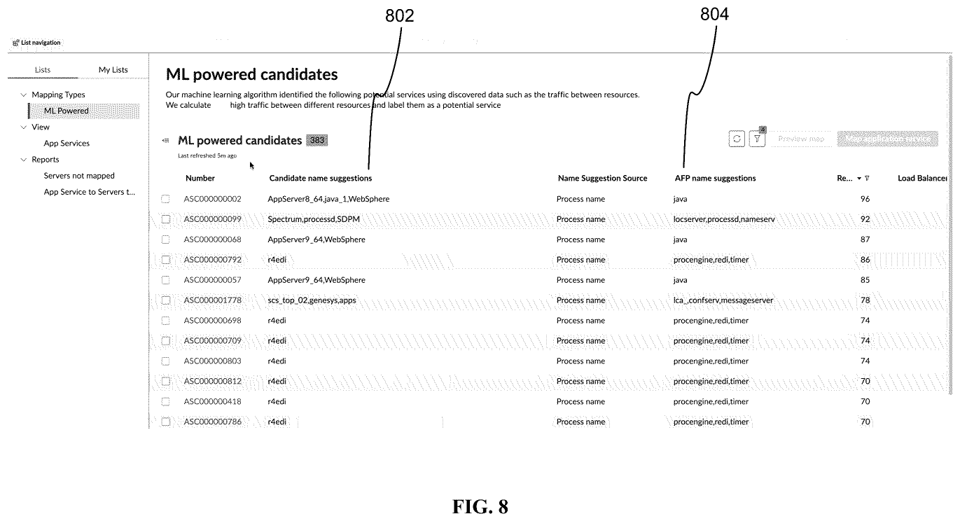

FIG. 8 shows an example of a graphical user interface (GUI) showing application service candidates that are determined according to an embodiment of the present disclosure.

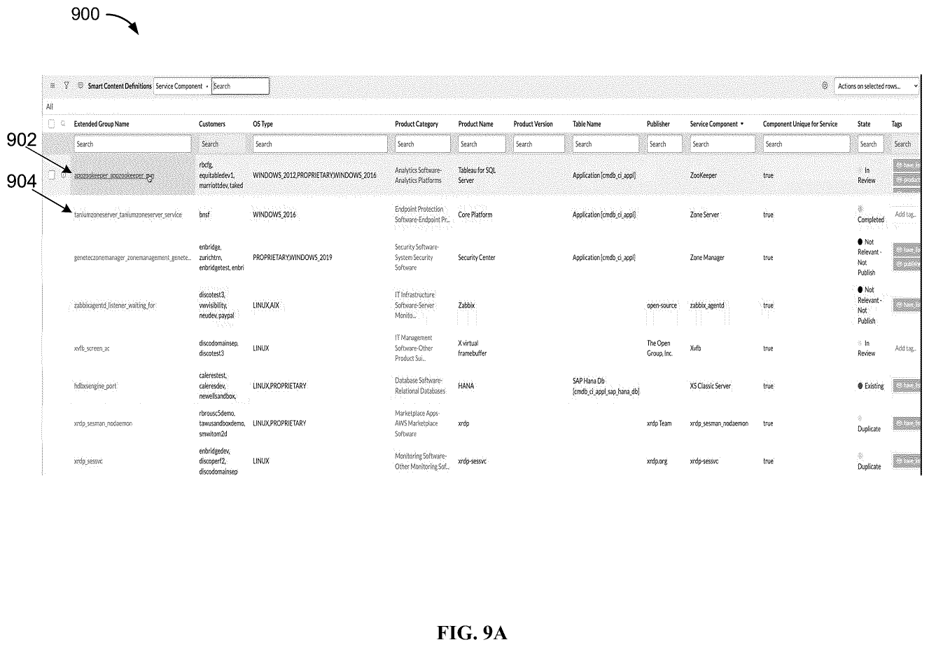

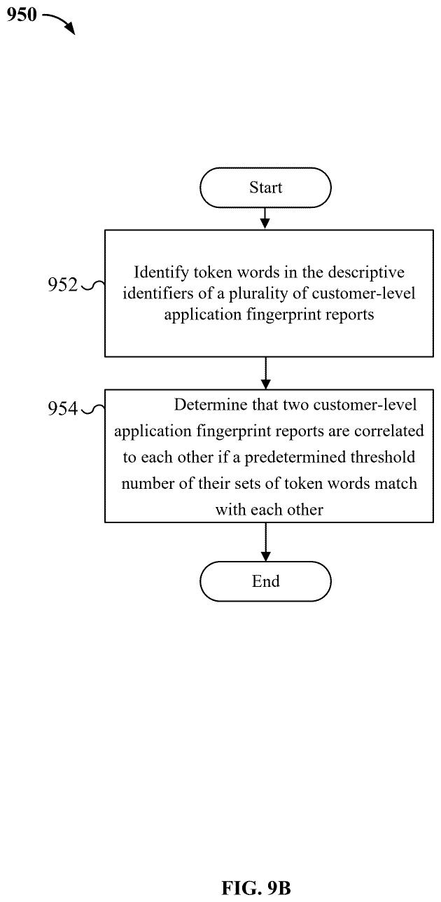

FIG. 9A shows an example of a graphical user interface showing the shared-level application fingerprint reports that are determined according to an embodiment of the present disclosure.

FIG. 9B is a flow chart illustrating an embodiment of a process 950 for identifying correlations among customer-level application fingerprint reports based on the reports having substantially identical or matching descriptive identifiers.

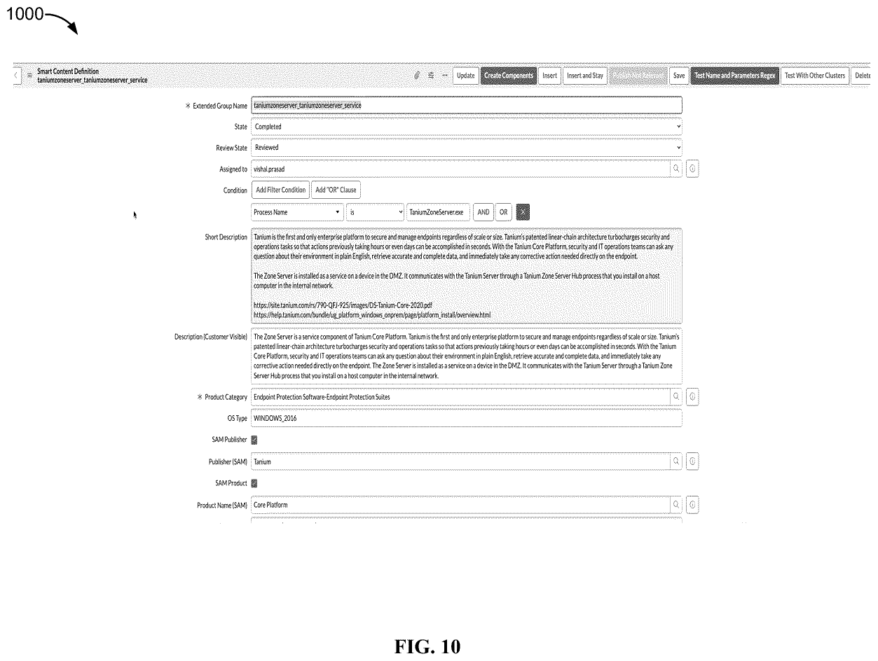

FIG. 10 shows an example of a graphical user interface (GUI) showing a software application classifier that is generated according to an embodiment of the present disclosure.

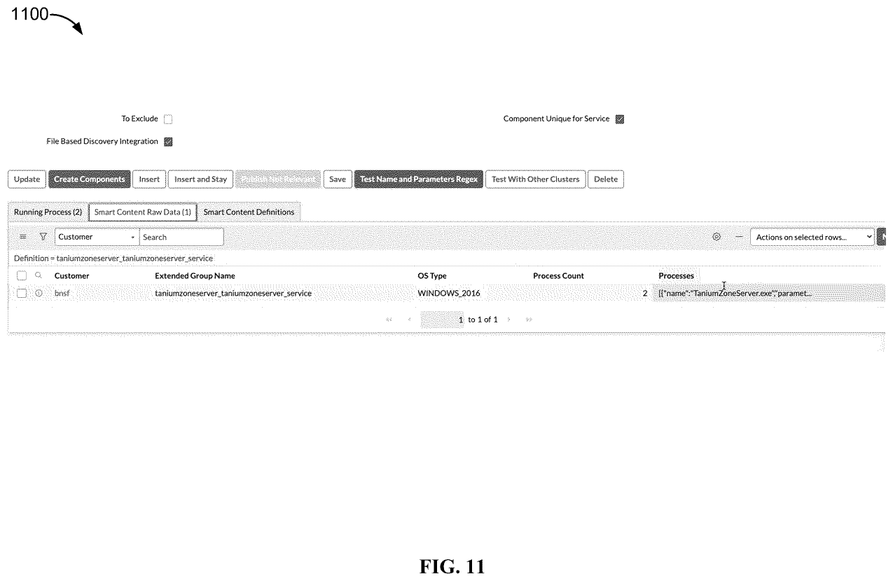

FIG. 11 shows an example of a graphical user interface (GUI) including various buttons, icons, and features for editing, validating, or testing a software application classifier.

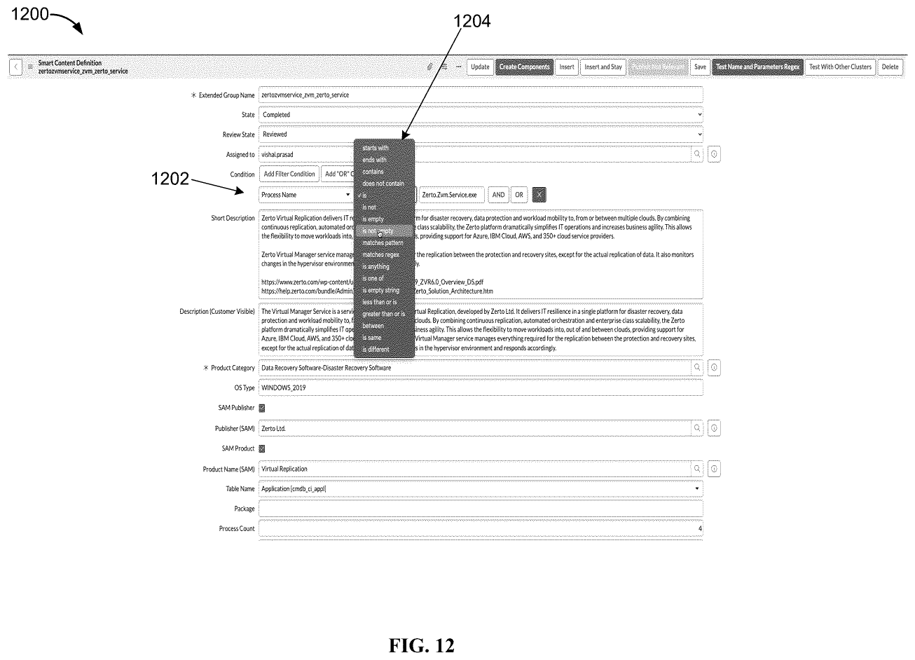

FIG. 12 shows an example of a graphical user interface including a drop-down menu for modifying one of the rules of the software application classifier.

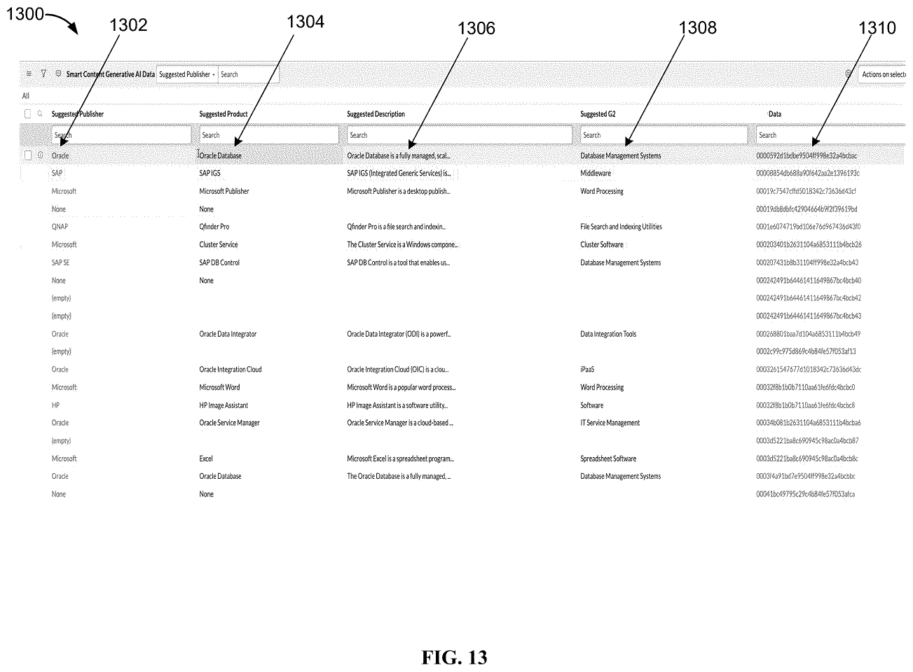

FIG. 13 shows an example of a graphical user interface that provides different categories of suggestions generated by a GenAI model.

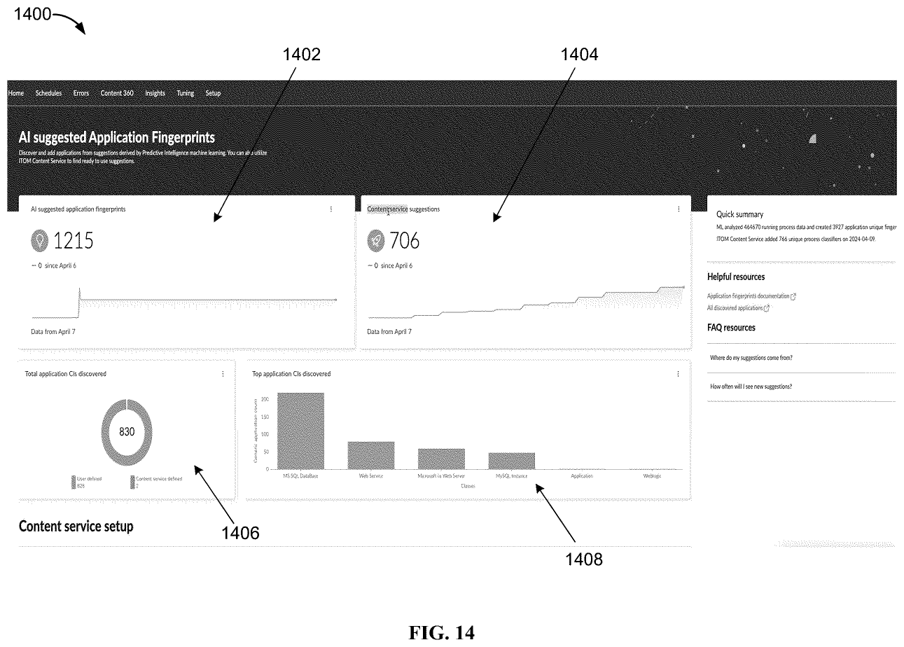

FIG. 14 shows an example of a graphical user interface that provides AI suggested Application Fingerprints.

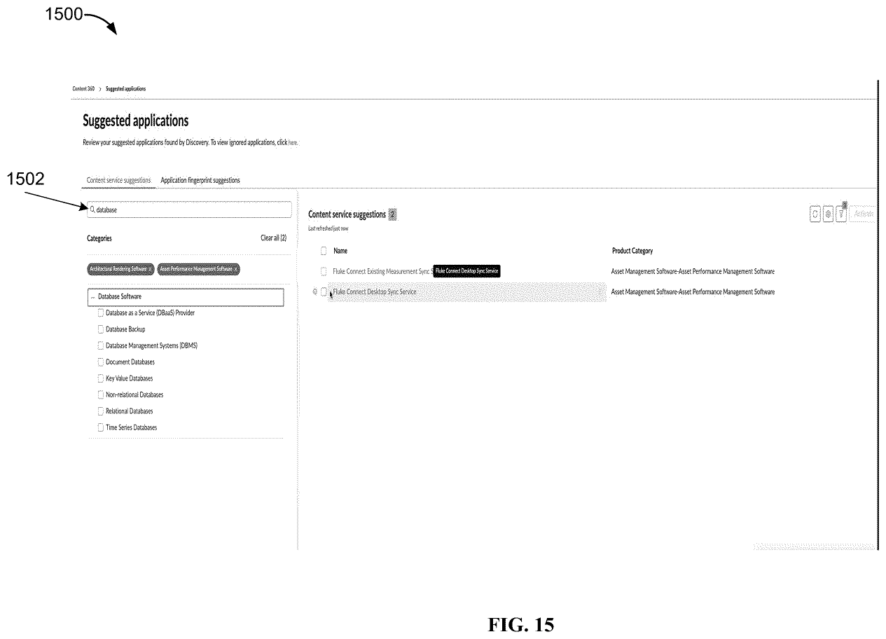

FIG. 15 shows an example of a graphical user interface that allows the user to conduct a search within the suggested applications.

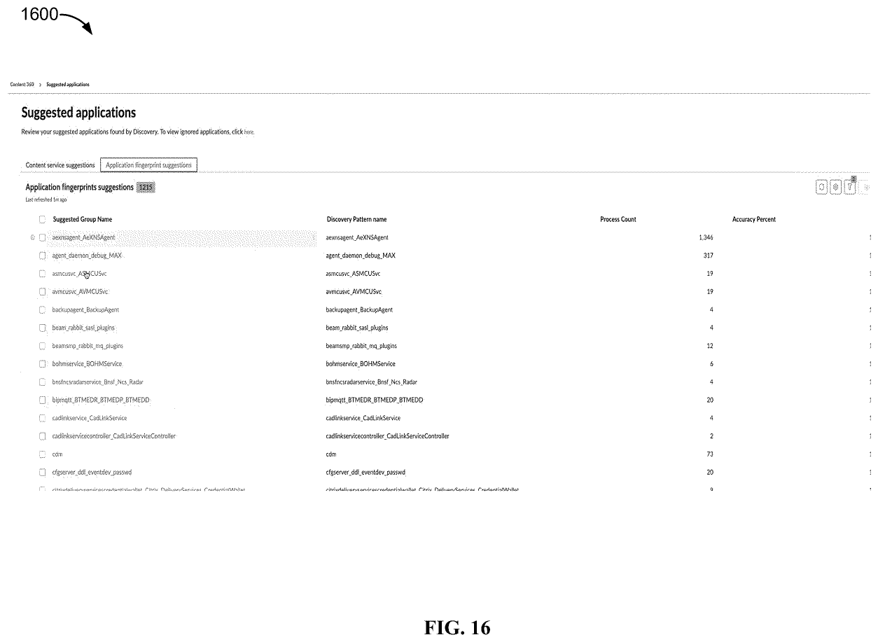

FIG. 16 shows an example of a graphical user interface that displays a plurality of suggested applications.

### DETAILED DESCRIPTION

Various implementation disclosed herein include a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the embodiments. The disclosure is described in connection with such embodiments, but the disclosure is not limited to any embodiment. The scope of the embodiments is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Information technology (IT) operations management (ITOM) is the management and strategic approach to planning, building, and operating digital services, technology, components, and application requirements in organizations. ITOM describes the individual processes and services that are administered by an IT department, including administrative processes, support for hardware and software, and services for internal and external clients. Effective ITOM ensures availability, performance, and efficiency within an organization's services and processes. ITOM defines the methods IT uses to manage services, support, and deployment to create consistency, quality of service, and reliability.

FIG. 1 illustrates an example of an Information technology (IT) operations management (ITOM) system 100. ITOM system 100, including an instance 118, may be used to manage the operation of a corporate network 102 of a customer company, organization, or entity. ITOM system 100 may be used to manage the operation of additional corporate networks (not shown in the figure) belonging to multiple customer companies, organizations, or entities as well. Corporate network 102 may include laptop computers 104, workstations 106, servers 108, databases 110, printers 112, and the like. Corporate network 102 may also include a server 114. A management, instrumentation, and discovery (MID) application (e.g., a Java application) may run on server 114 to facilitate communication and data movement between instance 118 of ITOM system 100 and the external applications, data sources, and services in corporate network 102 via a network 116. Network 116 may be any combination of public or private networks, including intranets, local area networks (LANs), wide area networks (WANs), radio access networks (RANs), Wi-Fi networks, the Internet, and the like.

Instance 118 includes various modules and components, including a plurality of modules 122 for discovery, event management, orchestration, service mapping, cloud management, operational intelligence, metric intelligence, and the like. Instance 118 further includes a configuration management database (CMDB) 124, which is a centralized file that functions as a comprehensive data warehouse, organizing information about an IT environment. CMDB clarifies the relationships between hardware, software components, and networks for improved configuration management. Configuration items (CIs) may include computers, devices, software, applications, or services in the CMDB. A CI's record may include all of the relevant data, such as manufacturer, vendor, location, and the like.

An important aspect of ITOM is the discovery of information technology (IT) assets that exist in a specific user environment. ITOM discovery is necessary in order to determine which IT assets need to be managed. One aspect of ITOM discovery is the discovery of applications associated with a customer company, organization, or entity. Processes that are running on the customer side may be automatically discovered and classified into different applications (e.g., identified by application fingerprints), which may be suggested and provided to the system administrators. For example, fingerprint-based discovery identifies running processes and organizes them into groups. These software process groupings become suggested applications or candidates. A system administrator may review the suggested applications and choose which ones to discover. A configuration management database (CMDB) configuration item (CI) class, a classifier, or a pattern for the new application CI class may be created automatically. By managing applications as configuration items, organizations can track their lifecycle, dependencies, relationships with other CIs, and associated information, such as versioning, ownership, and maintenance records. This enables better visibility, control, and governance over the applications within the IT environment.

The discovered applications may include non-standard applications or home-grown applications that are only running at a particular company or organization. The discovered applications may further include applications that are used across different companies or organizations. For example, these applications may be third-party applications that are created by independent software vendors (ISVs), developers, or organizations.

Identifying applications is challenging because applications comprise many software processes that may include numerous process parameters and different information. For example, it can be difficult to identify a true application behind processes because the process names are often not sufficiently descriptive. For example, many processes have “java” as the process name. Furthermore, examining process parameters that follow the process name is oftentimes not helpful because such process parameters are commonly used by various processes. Current methods for application discovery involve specifying particular rules for identifying particular applications. For example, a rule may identify SAP as an application if the word “SAP” is found. However, such an approach is cumbersome, requires thousands of rules, and may not be accurate.

In the present application, improved techniques for discovering software applications are disclosed. One aspect of the disclosure includes a method for discovering software applications. A plurality of reports corresponding to a plurality of candidate applications is obtained from a plurality of entities, wherein each report comprises information corresponding to a plurality of software processes associated with one of the plurality of candidate applications and running on one of the plurality of entities. Correlations among the plurality of reports corresponding to the plurality of candidate applications are identified. A software application classifier for automatically identifying one or more software processes associated with an application that is used across multiple entities is generated based at least in part on the identified correlations. The software application classifier is provided to at least one of the plurality of entities.

Additional implementations of the disclosure may include one or more of the following optional features. The first subset of the plurality of metric data streams is analyzed to identify a plurality of correlated groups, wherein each of the correlated groups has one or more corresponding member metric data streams selected from the first subset of the plurality of metric data streams, and wherein corresponding member metric data streams of one correlated group satisfy the metric independence criterion with respect to corresponding member metric data streams of another correlated group. The second subset of metric data streams is identified by selecting one corresponding member metric data stream as a representative metric data stream for each correlated group. In response to detecting an anomaly in one representative metric data stream of a particular correlated group, a responsive action for corresponding member metric data streams of the particular correlated group is initiated. At least some of the first subset of the plurality of metric data streams are analyzed to identify at least some of the plurality of correlated groups during a predetermined sampling time window, wherein the predetermined sampling time window is selected to be a length sufficient for determining correlation. The predetermined sampling time window is further selected based on a type of the at least some of the first subset of the plurality of metric data streams, wherein the type of the at least some of the first subset of the plurality of metric data streams is one of the following: noisy time-series data, seasonal time-series data, or trendy time-series data. Identifying the plurality of correlated groups comprises determining correlation coefficients and significance levels. Selecting the one corresponding member metric data stream as the representative metric data stream for each correlated group comprises generating a plurality of relative monitoring criticality levels associated with corresponding member metric data streams using a generative artificial intelligence (GenAI) model based at least in part on metric data stream names as inputs to the GenAI model, wherein the plurality of relative monitoring criticality levels associated with the corresponding member metric data streams sum up to one. Selecting the one corresponding member metric data stream as the representative metric data stream for each correlated group comprises selecting one of the corresponding member metric data streams with a highest relative monitoring criticality level as the representative metric data stream. The plurality of relative monitoring criticality levels associated with the corresponding member metric data streams is generated using the GenAI model based at least in part on a prompt that specifies one or more of the following: a definition of a relative monitoring criticality level, a range of values of the relative monitoring criticality levels, or a business field to detect anomalies.

Additional implementations of the disclosure may include one or more of the following optional features. At least some of the plurality of metric data streams that do not satisfy the monitoring criticality criterion are filtered out based on a predetermined monitoring criticality threshold. A plurality of monitoring criticality levels associated with the at least some of the plurality of metric data streams that do not satisfy the monitoring criticality criterion are generated. At least some of the plurality of metric data streams that do not satisfy the monitoring criticality criterion are filtered out in response to determining that the plurality of monitoring criticality levels is each less than the predetermined monitoring criticality threshold. The plurality of monitoring criticality levels associated with the at least some of the plurality of metric data streams that do not satisfy the monitoring criticality criterion are generated using a generative artificial intelligence (GenAI) model based at least in part on metric data stream names as inputs to the GenAI model. The plurality of monitoring criticality levels associated with the at least some of the plurality of metric data streams that do not satisfy the monitoring criticality criterion are generated using the GenAI model based at least in part on a prompt that specifies one or more of the following: a definition of a monitoring criticality level, a range of values of the monitoring criticality levels, or a business field to detect anomalies.

Another aspect of the disclosure provides a system with one or more processors and a memory coupled to the one or more processors. The memory is configured to provide the one or more processors with instructions. When executed, the instructions cause the one or more processors to obtain a plurality of metric data streams; identify a first subset of the plurality of metric data streams based on determining that each of the first subset of the plurality of metric data streams satisfies a monitoring criticality criterion; identify a second subset of metric data streams from the first subset of the plurality of metric data streams based on determining that each of the second subset of metric data streams satisfies a metric independence criterion; and perform anomaly detection with respect to the second subset of metric data streams.

Another aspect of the disclosure provides a computer program product embodied in a non-transitory computer readable medium and comprising computer instructions for obtaining a plurality of metric data streams; identifying a first subset of the plurality of metric data streams based on determining that each of the first subset of the plurality of metric data streams satisfies a monitoring criticality criterion; identifying a second subset of metric data streams from the first subset of the plurality of metric data streams based on determining that each of the second subset of metric data streams satisfies a metric independence criterion; and performing anomaly detection with respect to the second subset of metric data streams.

The current disclosure provides systems and methods for discovering software applications, including third-party applications that are used across multiple entities. In particular, the current disclosure is aimed at leveraging metadata to determine related processes. In some implementations, the method includes obtaining a plurality of reports corresponding to a plurality of candidate applications from a plurality of entities, wherein each report includes information corresponding to a plurality of software processes that are identified as software processes associated with one of the plurality of candidate applications and running on one of the plurality of entities. Further, the methods may include identifying correlations among the plurality of reports corresponding to the plurality of candidate applications. In some implementations, the method includes generating, based at least in part on the identified correlations, a software application classifier for automatically identifying one or more software processes associated with an application that is used across multiple entities. The software application classifier may be provided to at least one of the plurality of entities.

Implementations disclosed herein provide many benefits over known techniques. For example, automatically discovering shared applications based on correlations of the customer-level application fingerprint reports provided by different entities allows applications to be automatically discovered with minimal waste of time, resources, or effort Further, the implementations of the current disclosure eliminate the need for a system administrator to manually review a large number of software processes to identify and classify the applications or manually configure all the rules and conditions of the software application classifiers. A system administrator may also use a graphical user interface (GUI) to validate and test the software application classifiers and/or to create configuration items (CIs) and publish them.

The techniques disclosed herein allow for automatically identifying applications in a manner that is consistent and scalable. Configuration management database (CMDB) technology is improved by utilizing the techniques disclosed herein to more accurately and efficiently store information about software assets. A CMDB may be populated with configuration items (e.g., names of identified applications) to indicate which applications exist within a specific user environment.

FIG. 2A illustrates an example of a system 200 for identifying running processes associated with a plurality of companies or organizations and classifying them into software process groupings corresponding to different candidate applications. In some embodiments, system 200 may be at least a portion of ITOM system 100.

Each customer company, organization, or entity may provide its own set of metadata associated with its running processes. The metadata associated with the running processes of a customer company, organization, or entity may be stored in a customer database 202. The metadata may include the process names, process parameters, or any other information associated with the processes, which may be useful information for classifying the corresponding running processes into application or product groups.

Metadata associated with a computer process of a software application typically includes information that describes various aspects of the process. These metadata may be used for monitoring, troubleshooting, and managing the process. Examples of different types of metadata associated with a computer process that are described below may be useful for classifying processes into their corresponding applications. It should be recognized that these examples are not exhaustive and, thus, non-limiting.

Metadata associated with the computer processes may include the process names. Process names are the names of the executables or commands associated with the processes.

Each software product or application, when running on a computer or server, often corresponds to one or more processes that are actively executing in the system. These processes have names that typically correspond to the name of the software product or some identifiers associated with the product. For example, a process name may be “softwareproductname.exe,” such as “TaniumZoneServer.exe,” “oracle.exe,” “mysqld.exe,” and the like.

Metadata associated with the computer processes may include the process parameters or flags that are used to configure and control the behavior of the processes. The process parameters or flags may be arguments passed to a process when it was started. The parameters passed to a process may vary depending on the specific software and its configuration. Examples of parameters include port number, configuration file, logging level, concurrency settings, cache configuration, authentication parameters, performance tuning parameters, environment-specific parameters, and the like. For example, the process parameter or flag for “D: \Program Files\Tanium\TaniumZoneServer\TaniumZoneServer.exe-service” is “-service.”

The metadata associated with the running processes of a plurality of customer companies, organizations, or entities stored in the plurality of customer databases 202 may be uploaded to a shared database 204, which is a shared data pipeline. For example, shared database 204 (also referred to as the Continuance Delivery System (CDS)) may be used to synchronize records between the shared instance and the customer instances.

An ITOM content service discovery module analyzes (e.g., using artificial intelligence (AI) and machine learning (ML) models) the shared metadata associated with the running processes of the plurality of customer companies, organizations, or entities stored in shared database 204 and classifies the processes into software process groupings corresponding to different candidate applications. Each of the candidate applications may be identified by an application fingerprint (AFP) which may be stored in one or more ITOM database 206. The candidate application fingerprints may be downloaded from ITOM database 206 to the customer databases 202 via shared database 204, such that the candidate applications may be suggested and provided to the customers' system administrators.

In some embodiments, instead of the raw metadata described above, a customer may provide processed metadata that is generated based on the raw metadata associated with the running processes. For example, on the customer side, the raw metadata may be analyzed (e.g., using artificial intelligence (AI) and machine learning (ML) models) to classify the corresponding processes into software process groupings corresponding to different candidate applications (e.g., identified by application fingerprints), which are stored in the customer database 202. For example, if a customer classifies N different processes into a single software process grouping, then the application fingerprint report may include an application name and at least some of the metadata associated with the N processes that are classified into this application. The application name associated with the application fingerprint report is a descriptive identifier for the software process grouping. These application fingerprints may be referred to as customer-level application fingerprints. These customer-level application fingerprint reports may be uploaded to shared database 204.

The ITOM content service discovery module then analyzes (e.g., using artificial intelligence (AI) and machine learning (ML) models) the customer-level application fingerprint reports to identify software process groupings corresponding to different candidate shared applications that span across multiple customers. For example, if N1 different processes from one customer and N2 different processes from another customer are classified into a single shared application, then the application fingerprint report may include an application name and at least some of the metadata associated with the N1+N2 processes that are classified into this candidate shared application. The application name associated with the application fingerprint report is a descriptive identifier for the software process grouping. Each of the candidate shared applications may be identified by an application fingerprint, also referred to as a shared-level application fingerprint. These shared-level application fingerprint reports may be stored in one or more ITOM database 206. These reports may be downloaded from ITOM database 206 to the customer databases 202 via shared database 204, such that the candidate shared applications may be suggested and provided to the customers' system administrators.

The ITOM content service discovery techniques have many benefits. Software products that a customer is currently using may be reviewed. New configuration items (CIs) may be suggested and provided. Based on AI, application fingerprints and Simple Network Management Protocol (SNMP) system object identifiers (OIDs) are identified. Configuration items (CIs) are created for monitoring the IT infrastructures. Irrelevant processes that are not suitable candidates for CIs are identified. A higher number of products are identified by using AI capabilities that cluster and classify running application processes.

FIG. 2B illustrates an example of a process 250 for identifying running processes associated with a plurality of companies or organizations and classifying them into software process groupings corresponding to different candidate applications. In some embodiments, process 250 may be performed by at least a portion of system 200.

At 252, a plurality of reports corresponding to a plurality of candidate applications from a plurality of entities are obtained. Each report comprises information corresponding to a plurality of software processes that are identified as software processes associated with one of the plurality of candidate applications and running on one of the plurality of entities. For example, the ITOM content service discovery module may obtain customer-level application fingerprint reports from the customer databases 202, each corresponding to a different customer/entity, via shared database 204.

FIG. 3 is a block diagram illustrating an embodiment of a system for determining a descriptive identifier for a software process grouping. For example, the descriptive identifier may be a part of a customer-level application fingerprint uploaded from a customer database 202 to shared database 204 in FIG. 2A. In the example shown, system 300 includes client 302, network 304, and server 306. In various embodiments, client 302 is a computer or other hardware device that a user utilizes to interact with server 306. Examples of a client hardware device include: a desktop computer, a laptop computer, a tablet, a smartphone, or any other device. In various embodiments, the client hardware device includes a software user interface through which the user interacts with server 306. In various embodiments, the software user interface is utilized to determine descriptive identifiers for process groupings.

In the example illustrated, client 302 is communicatively connected to network 304. Requests are transmitted to and responses are received from server 306 via network 304. Examples of network 304 include one or more of the following: a direct or indirect physical communication connection, mobile communication network, Internet, intranet, Local Area Network, Wide Area Network, Storage Area Network, and any other form of connecting two or more systems, components, or storage devices together. In various embodiments, server 306 is a computer or other hardware component that stores a platform that includes process grouping identification functionality.

In the example shown, platform 308 runs on server 306. In some embodiments, platform 308 is an instance of a platform as a service (PaaS). In various embodiments, platform 308 includes a collection of programs or pieces of software (not shown in FIG. 3) designed and written to fulfill various particular purposes (e.g., information technology, human resources, cybersecurity, and/or other purposes). Platform 308 is communicatively connected to data table 310 and causes data to be read from and/or stored in data table 310. Data table 310 is a structured and organized collection of data stored on server 106. It is also possible for data table 310 to be located at least in part on a server separate from but communicatively connected to server 306.

In some embodiments, a software user interface of client 302 controls platform 308 to populate a CMDB with information associated with software assets. For example, the software assets can be applications (comprised of various software processes) running on server 306 or a separate computer system (not shown in FIG. 3) communicatively connected via network 304. In various embodiments, the various software processes have been clustered into groups corresponding to software applications. In some embodiments, descriptive information associated with the software processes are stored in data table 310. Examples of descriptive information include process command lines, process parameters, process names, and process paths. This descriptive information is also referred to herein generally as parameters. Client 302 may instruct platform 308 to analyze the descriptive information associated with the software processes to determine a descriptive identifier for each clustered group of processes (corresponding to an application) to store in the CMDB.

In the example shown, platform 308 includes descriptive identifier generator 312 as a software component of platform 308. In various embodiments, for each process grouping's set of descriptive information (e.g., process parameters, process command lines, process names, and process paths) stored in data table 310, descriptive identifier generator 312 automatically generates a corresponding descriptive identifier for that process grouping. Process groupings are formed before descriptive identifiers for the process groupings are generated. Process groupings can be formed by utilizing various approaches. For example, processes can be clustered based on various process-related attributes and information. Such attributes and information can include process parameters, process command lines, and process names. When performing data clustering to determine process groupings, process (file) paths are typically not utilized in order to produce better clustering results and allow for grouping of similar applications that are installed in different locations. However, when generating descriptive identifiers, in various embodiments, file paths are taken into account because they have a high potential to include true application names. In some embodiments, software processes are clustered using density-based spatial clustering of applications with noise (DBSCAN or HDBSCAN). Other clustering approaches that may be used include K-means clustering, mean-shift clustering, expectation-minimization clustering using Gaussian mixture models, agglomerative hierarchical clustering, and various other approaches known in the art.

After process groupings have been created, descriptive identifier generator 312 generates a descriptive identifier for each process grouping based on parameters (descriptive information) associated with that process group (e.g., process parameters, process command lines, process names, and process paths). In various embodiments, descriptive identifier generator 312 decomposes the parameters (descriptive information) associated with a process grouping into a set of token words to be further processed. In various embodiments, the token words are normalized, which, as described in further detail herein, can include converting token word letters to lowercase, removing numbers, and removing special characters (e.g., non-alphabetic characters). In various embodiments, as described in further detail herein, token words are filtered to remove high frequency words that do not aid in differentiating process groupings. In various embodiments, as described in further detail herein, token words are stemmed (e.g., converted to a root form). In some embodiments, a list of most common/frequently processed token words for each process group (e.g., a list of ten token words) is presented to a user to help the user identify an application corresponding to the process group. The user may create an application name (e.g., of an enterprise application) based on the list of token words. The application name can correspond to a configuration item with which to populate a CMDB.

In various embodiments, descriptive identifier generator 312 determines a descriptive identifier associated with a specific process grouping from the processed token words for the specific process grouping. In some embodiments, a small group of processed token words are selected (e.g., three most common/frequent processed token words in the specific process grouping) to form a suggested process grouping name. In many scenarios, the suggested process grouping name can be adopted by a user as a true application name. In various embodiments, the user is able to modify/refine the suggested process grouping name.

In the example shown, portions of the communication path between the components are shown. Other communication paths may exist, and the example of FIG. 3 has been simplified to illustrate the example clearly. Although single instances of components have been shown to simplify the diagram, additional instances of any of the components shown in FIG. 3 may exist. For example, additional clients that connect to server 306 may exist. The number of components and the connections shown in FIG. 3 are merely illustrative. Components not shown in FIG. 3 may also exist.

FIG. 4 is a flow chart illustrating an embodiment of a process 400 for determining a descriptive identifier for a software process grouping. In some embodiments, the process of FIG. 4 is performed by descriptive identifier generator 312 of platform 308 of FIG. 3.

At 402, one or more process paths of one or more processes identified as belonging to a specific service candidate among a plurality of service candidates are obtained. In various embodiments, the specific service candidate and the plurality of service candidates have been formed using a clustering approach. In some embodiments, the parameters are stored in data table 310 of FIG. 3 or another data storage location. In some embodiments, the one or more process paths include other parameters such as process command lines, process parameters, process names, and process paths. Process paths (e.g., installation paths) can be informative because in many scenarios a user has installed an application in a file system directory that has a path that includes the application's name. Stated alternatively, the application's name may be in the path of an executable for the application, which means the path can include highly descriptive information. In some embodiments, a CMDB is populated with processes that are running and the CMDB includes the parameters described above. In some embodiments, data table 310 of FIG. 3 is part of the CMDB. In various embodiments, the obtained parameters are process command lines, process parameters, process names, process paths, etc. of all the processes in the specific process grouping combined together. Shown below is an example portion of obtained parameters for one process.

“C:\Program Files\Java\jdk1.8.0_77\bin\java”-D [Server: server-one]-XX:PermSize=256m-XX:MaxPermSize=256m-Xms64m-Xmx512m-server-Djava.net.preferIPV4Stack=true-Djboss.home.dir=C:\wildfly-8.0.0.Final(1)\wildfly-8.0.0.Final-Djboss.modules.system.pkgs=org.jboss.byteman-Djboss.server.log.dir=C:\wildfly-8.0.0.Final(1)\wildfly-8.0.0.Final\domain\servers\server-one\log-Djboss.server.temp.dir=C:\wildfly-8.0.0.Final(1)\wildfly-8.0.0.Final\domain\servers\server-one\tmp-Djboss.server.data.dir=C:\wildfly-8.0.0.Final(1)\wildfly-8.0.0.Final\domain\servers\server-one\data-Dorg.jboss.boot.log.file=C:\wildfly-8.0.0.Final(1)\wildfly-8.0.0.Final\domain\servers\server-one\log\server.log-Dlogging.configuration=file: C:\wildfly-8.0.0.Final(1)\wildfly-8.0.0.Final\domain\configuration/logging.properties-jar C:\wildfly-8.0.0.Final(1)\wildfly-8.0.0.Final\jboss-modules.jar-mp C:\wildfly-8.0.0.Final(1)\wildfly-8.0.0.Final\modules org.jboss.as.server

In the example above, the first line includes a command line that includes a process name (“java”) and a path (“C:\Program Files\Java\jdk1.8.0_77\bin\”). As is often the case, the process name is not highly descriptive (“java” being a generic process name that is not uniquely indicative of an application to which it belongs). In the example above, what follows are various process parameters for the java process.

At 404, eligible token words in the one or more process paths are identified. In various embodiments, a set of token words is generated from a block of text (e.g., text comprising the obtained parameters in the example above). In some embodiments, token words are extracted by regarding the block of text as token words separated by specified delimiters (e.g., blank spaces, periods, slashes, numerical values, specific character sequences, etc.) that define boundaries of token words. In the example above, extracted token words include jboss, wildfly, as, server, djboss, server, data, log, and so forth. Examples of delimiters separating token words in the example above include periods, slashes, and hyphens. For example, the token word “wildfly” is seen between the delimiters “\” and “-” (e.g., “\wildfly-”). As another example, the token word jboss is seen between period (“.”) delimiters (e.g., “Dorg.jboss.boot”). Unique token words (such as the product or publisher) in the process name may be particularly useful. In various embodiments, token words that appear in a list of ineligible token words are removed to arrive at a list of eligible token words. Oftentimes, these ineligible token words are very common words that have little value in differentiating software processes. For example, “server” in the above list of extracted token words may be removed because it is a very common word that is associated with many software processes.

At 406, the eligible token words are processed to select a subset of the eligible token words that are likely descriptive of the specific service candidate. Examples of processing, described in further detail herein, include normalization, frequency-based filtering, and stemming. For example, in the above example, “Djboss” may be normalized to “djboss” by converting uppercase letters to lowercase. Words that appear frequently in descriptive text associated with other process groupings (e.g., “data,” “log,” etc.) may be filtered out. Words in plural form, such as “modules,” may be stemmed to their singular forms (e.g., “module”). The processing can be regarded as removing noise to arrive at a subset of eligible token words that are more likely to be descriptive of the specific service candidate.

In various embodiments, sampling is performed to select the subset of eligible token words. For example, all processes are scanned and a subset (e.g., 100,000 processes) is selected with an objective of obtaining a statistically normal distribution. For example, clustering is performed to divide the processes into groups. Processes from different groups are known to be different, because they were not clustered together. One or more processes are selected from each group. Next, only a subset of words (e.g., 10,000 words) from the 100,000 processes is saved to form the subset of eligible token words.

At 408, the selected subset of the eligible token words is utilized to determine a descriptive identifier associated with the specific service candidate. In some embodiments, the descriptive identifier is a combination of the process name and a few eligible token words that appear frequently in the obtained parameters associated with the specific process grouping but appear relatively infrequently in obtained parameters of other process groupings. Stated alternatively, in some embodiments, the descriptive identifier is the process name with a few differentiating keywords appended. With respect to the above example, the descriptive identifier that is determined may be “java_jboss_wildfly_as.” Here, “java” is the process name and “jboss,” “wildfly” and “as” are eligible token words ordered by frequency of occurrence in the obtained parameters. In this example, token words are separated by an underscore (“_”) character. In various embodiments, the descriptive identifier is a suggested application name for the specific process grouping.

FIG. 5 is a flow chart illustrating an embodiment of a process 500 for identifying eligible token words. In some embodiments, the process of FIG. 5 is performed by descriptive identifier generator 312 of FIG. 3. In some embodiments, at least a portion of the process of FIG. 5 is performed in 404 of FIG. 4.

At 502, a set of token words is generated from input text. In various embodiments, the input text is a block of text that includes descriptive information associated with one or more software processes. Examples of descriptive information in the input text include process command lines, process parameters, process names, and process paths. In various embodiments, the input text includes various text characters, such as punctuation, blank spaces, numbers, and special characters that have little semantic content but surround text strings (e.g., words) in the input text that do have semantic content. In various embodiments, the set of token words is generated based on utilizing such punctuation (e.g., periods, commas, colons, semi-colons, etc.), blank spaces, numbers, and special characters (e.g., slashes, dashes, asterisks, ampersands, etc.) as delimiters to separate instances of token words. Special strings (e.g., “-XX” in the example described with respect to FIG. 4) may also be used as delimiters. In general, delimiters can be customized according to the information content in the input text.

At 504, specified token words are removed from the set of token words based on a list of ineligible token words. The list of ineligible token words is also referred to as a blacklist. In various embodiments, token words in the blacklist are common words that appear frequently in text associated with many software process groupings, thereby rendering these words unhelpful with respect to identifying different process groupings. Stated alternatively, these words have little descriptive value as identifiers of software applications. Examples of token words that may appear in the blacklist include “server,” “memory,” “daemon,” “service,” and other common information technology words.

FIG. 6 is a flow chart illustrating an embodiment of a process 600 for processing eligible token words. In some embodiments, the process of FIG. 6 is performed by descriptive identifier generator 312 of FIG. 3. In some embodiments, at least a portion of the process of FIG. 6 is performed at 406 of FIG. 4.

At 602, token words in a set of token words are normalized. Examples of normalization include converting any capitalized characters to lowercase, removing numbers, and removing other non-alphabetic characters. Normalization reduces the chance that semantically similar words are not counted together due to minor formatting differences. For example, the words “Wildfly,” “wildfly,” “wildfly@,”, and “wildfly1” would all be counted as “wildfly” after normalization.

At 604, frequency-based filtering is performed on the set of token words. As described above, common information technology words (e.g., “server,” “memory,” “daemon,” “service,” etc.) may be filtered out based on a blacklist approach. However, different user environments (e.g., different data centers) may have different frequently used words. Thus, oftentimes, a more flexible frequency-based filtering approach is required in addition to the blacklist approach. In various embodiments, a TF-IDF or similar approach is utilized. In various embodiments, for each token word in the set of token words, a term frequency (TF) of the token word in input text associated with a specific process grouping (e.g., process command lines, process parameters, etc.) is calculated. Stated alternatively, a frequency of the token word in a current group is determined. In some embodiments, TF is calculated as the number of times the token word appears in input text associated with the specific process grouping divided by the total number of token words in the input text. Thus, TF is proportional to how often the token word appears in the current group for which a descriptive identifier is sought.

In addition, an inverse document frequency (IDF) of the token word is determined. IDF measures frequency of the token word in input text associated with other process groupings. In some embodiments, IDF is calculated as a logarithm of a quotient, wherein the quotient is the total number of process groupings divided by the number of process groupings whose associated input text includes the token word. Thus, IDF is inversely proportional to how often the token word appears across all groups. For example, if the token word appears in all groups, IDF is equal to log(1)=0. In some embodiments, a TF-IDF score is computed as TF multiplied by IDF. Other formulations for TF and IDF (and thus TF-IDF) are also possible. A common feature across various formulations is that the TF-IDF score increases proportionally to the number of times the token word appears in the current group and is offset by the number of groups in which the token word appears, which deemphasizes token words that appear more frequently in general.

The TF-IDF score for the token word corresponds to how specific the token word is to the current group (e.g., the specific process grouping) and thus how valuable the token word is for distinctly identifying the current group. For example, in the obtained parameters example described with respect to FIG. 4, the token word “domain” appears frequently in the obtained parameters for that specific process grouping. Thus, TF for “domain” would be high. However, “domain,” being a common information technology word, probably appears frequently in obtained parameters for other process groupings, meaning IDF for “domain” would be low and would offset the high TF when multiplied with it. The token word “wildfly,” on the other hand, appears frequently in the obtained parameters for that specific process grouping, and, being an uncommon word, is unlikely to appear frequently in obtained parameters for other process groupings. Thus, TF for “wildfly” would be high and IDF for “wildfly” would not be low, meaning TF-IDF for “wildfly” would be high. In various embodiments, TF-IDF or a similar statistic is applied to each token word to prioritize token words that appear frequently for the process grouping for which a descriptive identifier is being determined but relatively infrequently for other process groupings.

In various embodiments, frequency-based filtering removes frequently appearing words and/or low scores based on a threshold. For example, a frequency threshold (such as the top 5% of frequently appearing words) is used to remove those words that meet the threshold. For example, if all processes are installation paths of Java, then Java is not a suggested name. As another example, a score threshold (such as 0.1) removes those words that are below the threshold. The threshold values are merely exemplary and not intended to be limiting. An appropriate value for a specific application may be selected to optimize user experience.

In various embodiments, the TF and IDF portions may be performed separately. For example, the TF portion which is relatively computationally costly may be run first and the resultant values stored in a table. The IDF portion may be run at a different time. The TF portion may be performed prior to user interaction with the platform (e.g., interaction with the GUI shown in FIG. 8), while the IDF portion is performed in real-time or near real-time while the user is interacting with the platform.

At 606, stemming is performed on the token words in the filtered set of token words. Various examples used herein describe stemming in the English language. It is also possible to apply stemming to words in other languages. In various embodiments, stemming is performed to convert inflected or derived words (e.g., grammatical variants) into their stem/base/root forms. For example, strings such as “transmitted,” “transmitting,” “transmitter,” “transmittal,” “transmits,” and so forth may be reduced to the stem “transmit.” In addition, stemming that is specific to information technology can also be performed to consolidate word tokens that are information technology variants of one another. For example, strings such as “TLSv1,” “TLSv2,” “TLSver3” may be reduced to the stem “TLS” because “v1,” “v2,” “ver3,” and other variants (indicating a version, e.g., of software) are commonly used in information technology contexts. Stemming may be performed according to a rules-based approach (e.g., by looking up word variants in a dictionary). Stemming may also be performed by applying a machine learning model trained to perform stemming. For example, a convolutional neural network may be trained on token words and their variants.

A benefit of stemming is consolidating token words to more accurately reflect token word frequencies. In some embodiments, word count frequencies and associated statistics of corresponding token words are combined when token words are determined through stemming to belong to a common root form. For example, TF-IDF scores may be combined. It is also possible to perform stemming before performing the frequency-based filtering described above, in which case, no combination of word count frequencies and associated statistics (e.g., TF-IDF scores) is needed.

At 608, a processed list of token words is generated. In various embodiments, a frequency score is associated with each token word in the processed list of token words. For example, in some embodiments, each token word has a corresponding TF-IDF score to reflect how frequently that token word appears in a specific process grouping relative to other process groupings, thereby providing a measure of that token word's value as a descriptive identifier unique to the specific process grouping.

FIG. 7 is a flow chart illustrating an embodiment of a process 700 for utilizing eligible token words to determine a descriptive identifier. In some embodiments, the process of FIG. 7 is performed by descriptive identifier generator 312 of FIG. 3. In some embodiments, at least a portion of the process of FIG. 7 is performed in 408 of FIG. 4.

At 702, a list of token words is arranged based on word frequency. In some embodiments, the list of token words is ordered based on TF-IDF score. It is also possible to order the list of token words based on a simpler frequency metric, such as token word count.

At 704, a specified number of most frequent token words from the list of token words are selected. Typically, the most frequent token words according to word frequency are placed at the top of the list of token words. In some embodiments, the specified number of most frequent token words is a relatively small number (e.g., two to four). In some embodiments, a larger group of most frequent token words is also generated (e.g., top ten token words). The larger group of most frequent token words may be provided to a user so that the user can select a smaller subset of these token words to use in a descriptive identifier for a specific process grouping.

At 706, a descriptive identifier for a service candidate is generated based on the selected most frequent token words. In some embodiments, the descriptive identifier is automatically generated based on the selected most frequent token words. For example, if the selected most frequent token words are “jboss,” “wildfly,” and “as” in order of frequency and a common process name in the service candidate is “java,” then “java_jboss_wildfly_as” may be generated as the descriptive identifier. In various embodiments, the descriptive identifier that is generated is a suggested service candidate name that a user is able to modify. As described above, it is also possible to present a larger number of most frequent token words to a user so that the user can select a subset of token words from which to generate the descriptive identifier. The above example is merely descriptive. It is possible to generate the descriptive identifier using a different number of most frequent token words. For example, using the top most frequent token word, the generated descriptive identifier would be “java_jboss.” Using fewer token words for the descriptive identifier can improve readability. However, using fewer token words also increases the likelihood that the descriptive identifier is not unique.

FIG. 8 shows an example of a graphical user interface (GUI) showing application service candidates that are determined according to an embodiment of the present disclosure. In various embodiments, the disclosed techniques for naming candidate application services find applications in a platform, whose graphical user interface is shown here. The disclosed techniques determine candidate names 802 for each of the potential services. By contrast, the AFP name suggestions 804 are those determined by conventional techniques. As further described herein, conventional naming techniques do not provide sufficiently good names.

As used herein a “candidate application service” (sometimes simply a “candidate”) refers to a connected group of processes. Processes may be connected to each other via ports. For example, a first process listens on a particular port and a second process is connected to the first process via the particular port. Processes may be connected in a hierarchical order. For example, process A is connected to process B, and then process B connects to other processes, etc. The candidate for the service may be an identification of an entry point for this group of connected processes. A candidate may be thought of as a type of process grouping, specifically a group of connected processes. A process grouping is a list of processes that are part of the same application fingerprint. The processes within a process grouping are not necessarily connected.

Applications may be named and discovered based on suggestions. For example, ServiceNow Predictive Intelligence automatically classifies and categorizes the discovered running processes, as application fingerprints, and provides suggestions. The naming of the suggested applications may be determined using the disclosed techniques. Instead of having the user manually configure entry points and look for connections, machine learning capabilities are used to automatically generate and name candidates.

Conventional naming techniques do not provide sufficiently good names. For example, the suggested names might not be descriptive and therefore are not useful to the user reviewing the information. Referring to the first row, a name 804 determined by conventional techniques is “java,” which may not be particularly helpful for a user. By contrast, a name 802 determined by the disclosed techniques includes “Web Sphere,” which is more descriptive than “java.” Although the foregoing embodiments have been described in some detail for purposes of clarity of understanding, the disclosure is not limited to the details provided. There are many alternative ways of implementing the disclosure. The disclosed embodiments are illustrative and not restrictive.

Referring back to FIG. 2B, at 254 of process 250, correlations among the plurality of reports corresponding to the plurality of customer-level candidate applications are identified. In some embodiments, correlated reports may be combined to form reports of shared-level application fingerprint reports. At least some of the shared-level application fingerprint reports are application fingerprint reports corresponding to third-party applications that are installed and deployed by multiple customers/entities.

In one illustrative example, entity #1 provides N1 number of customer-level application fingerprint reports, entity #2 provides N2 number of customer-level application fingerprint reports, and entity #3 provides N3 number of customer-level application fingerprint reports. Each entity shares the customer-level application fingerprint reports of a number of non-standard applications or home-grown applications that are running on that entity alone. In addition, each entity shares a customer-level application fingerprint report of a third-party application A that is used across different entities. In this example, the customer-level application fingerprint reports of the third-party application obtained from entity #1, entity #2, and entity #3 should be closely matching each other and therefore correlations among these customer-level application fingerprint reports that are above a certain predetermined threshold may indicate that the three customer-level application fingerprint reports belong to the same application that is used across the three entities. Accordingly, the customer-level application fingerprint reports of third-party application A obtained from the three entities may be combined to form a shared-level application fingerprint report for identifying the third-party application A.

FIG. 9A shows an example of a graphical user interface 900 showing the shared-level application fingerprint reports that are determined according to an embodiment of the present disclosure. For example, row 902 shows an application fingerprint report with an identifier (Extended Group Name) of “appzookeeper_appzookeeper_run,” and row 904 shows an application fingerprint report with an identifier of “taniumzoneserver_taniumzoneserver_service.” Each row of candidate applications includes a plurality of fields, including the Extended Group Name, Customers, OS Type, Product Category, Product Name, Product Version, Table Name, Publisher, Service Component, Component Unique for Service, State, Tags, and the like. The application fingerprint report for “appzookeeper_appzookeeper_run” (row 902) includes software processes from a plurality of entities/customers that are correlated with each other. The customers are “rbcfg,” “equitabledev1,” “marriottdev,” and “taked.” The application fingerprint report for “taniumzoneserver_taniumzoneserver_service” (row 904) includes software processes that are correlated with each other and running on a single customer site. The customer is “bnsf.”

Different techniques (e.g., machine learning techniques) may be used to determine whether certain customer-level application fingerprint reports are correlated with each other above a certain predetermined threshold. Multiple techniques may be used in combination to determine whether certain customer-level application fingerprint reports are correlated with each other above a certain predetermined threshold.

In some embodiments, processes belonging to the customer-level application fingerprint reports can be clustered based on various process-related attributes and information. Such attributes and information can include process parameters, process command lines, and process names. The processes that are clustered together are determined as correlated with each other. When performing clustering to determine process groupings, process (file) paths are typically not utilized in order to produce better clustering results and allow for grouping of similar applications that are installed in different locations. In some embodiments, software processes are clustered using density-based spatial clustering of applications with noise (DBSCAN or HDBSCAN). Other clustering approaches that may be used include K-means clustering, mean-shift clustering, expectation-minimization clustering using Gaussian mixture models, agglomerative hierarchical clustering, and various other approaches known in the art.

In some embodiments, customer-level application fingerprint reports are determined as correlated with each other based on the reports having substantially identical or matching descriptive identifiers.

FIG. 9B is a flow chart illustrating an embodiment of a process 950 for identifying correlations among customer-level application fingerprint reports based on the reports having substantially identical or matching descriptive identifiers.

At 952, token words in the descriptive identifiers of a plurality of customer-level application fingerprint reports are identified. In various embodiments, each descriptive identifier, which is a block of text, is divided into a set of token words. In some embodiments, token words are extracted by regarding the block of text as token words separated by specified delimiters (e.g., blank spaces, periods, slashes, numerical values, specific character sequences, etc.) that define boundaries of token words. Suppose that the descriptive identifier is “java_jboss_wildfly_as,” then the extracted token words include “java,” “jboss,” “wildfly,” and “as.” The delimiters separating the token words in the example above are an underscore “_”character. However, other examples of delimiters may include periods, slashes, hyphens, and the like.

At 954, it is determined that two customer-level application fingerprint reports are correlated to each other if a predetermined threshold number of their sets of token words match with each other. In some embodiments, the predetermined threshold number may be set as the number of token words−1. For example, if the descriptive identifier for the first customer-level application fingerprint report is “java_jboss_wildfly_as,” then customer-level application fingerprint reports with descriptive identifiers such as “java_jboss_wildfly_aa,” “ab_java_jboss_wildfly,” or “java/jboss_ac_wildfly” are determined as correlated with the first customer-level application fingerprint report. This is because each matching descriptive identifier has at least three token words identical to three of the token words of “java_jboss_wildfly_as.”

An advantage of discovering the shared-level application fingerprint reports based on the correlations of the customer-level application fingerprint reports provided by different entities is that it allows for automatically identifying third-party applications in a manner that is consistent and scalable. Configuration management database (CMDB) technology is improved by utilizing the techniques disclosed herein to more accurately and efficiently store information about software assets. A CMDB may be populated with configuration items (e.g., names of identified applications) to indicate which applications exist within a specific user environment. Third-party software products that multiple customers are currently using may be reviewed. New configuration items (CIs) may be suggested and provided. Configuration items (CIs) are created for monitoring the IT infrastructures. Irrelevant processes that are not suitable candidates for CIs are identified.

Referring back to FIG. 2B, at 256 of process 250, a software application classifier for automatically identifying one or more software processes associated with an application that is used across multiple entities is generated. The generation is based at least in part on the identified correlations at step 254 of process 250. At 258, the software application classifier is provided to at least one of the plurality of entities.

A software application classifier is a discovery classifier of software applications/products, which includes a set of rules used to identify and categorize software installations or instances discovered within an organization's IT environment. These classifiers help in inventory management, software license compliance, and overall IT asset management. A software application classifier may include features for identification. Criteria may be defined to identify software application installations based on attributes including file paths, registry keys, executable names, and the like. A software application classifier may include features for categorization. Software application installations may be categorized based on predefined rules, specifying attributes including type, category, vendor, version, and the like. For example, a software application classifier rule may categorize Adobe Photoshop installations as a graphic design software from Adobe Systems. A software application classifier may include features for normalization. To ensure consistency and accuracy in representing software application installations, standard naming conventions and data formats may be applied. A software application classifier may include features for license management. Software application installations are associated with corresponding license records to track usage and ensure compliance with license agreements. A software application classifier can also help in mapping dependencies between software applications and their underlying components. This mapping provides insights into the relationships between different software applications and their dependencies, facilitating impact analysis, change management, and troubleshooting. A software application classifier may include features for customization. Administrators are allowed to create custom discovery classifiers tailored to their organization's software landscape and requirements. Custom discovery classifiers can be created using a discovery classification editor, where administrators can define rules and conditions based on their knowledge of the organization's software inventory.

The shared-level application fingerprint reports determined at step 254 of process 250 are used to generate the software application classifiers for software application discoveries. A shared-level application fingerprint report may be used to initialize a software application classifier. For example, the contents of a shared-level application finger report may be used to populate the fields, rules, or tables of the software application classifier, as default or initial values.

FIG. 10 shows an example of a graphical user interface (GUI) 1000 showing a software application classifier that is generated according to an embodiment of the present disclosure. The software application classifier includes different fields, rules, or tables, including “Extended Group Name,” “State,” “Review State,” “Assigned to,” “Condition,” “Short Description,” “Description (Customer Visible),” “Product Category,” OS Type,” “SAM Publisher,” “Publisher (SAM),” “SAM Product,” “Product Name (SAM),” and the like. Each of the fields, rules, or tables of the software application classifier may be initialized based on the contents of its associated shared-level application fingerprint report. For example, the “Extended Group Name” is initialized as “taniumzoneserver_taniumzoneserver_service,” the descriptive identifier of the associated shared-level application finger report. The “Short Description” or “Description (Customer Visible)” may be initialized based on some of the information about the software application included in the shared-level application fingerprint report.

In some embodiments, the software application classifiers allow a system administrator to adopt the initial groupings of the software processes. Automatically adopting the initial groupings of the software processes based on the shared-level application fingerprint reports is advantageous because applications are automatically discovered with minimal waste of time, resources, or effort, thereby eliminating the need for a system administrator to manually review a large number of software processes to identify and classify the applications or manually configure all the rules and conditions of the software application classifiers. A system administrator may also use the GUI to validate and test the software application classifiers. A system administrator may also use the GUI to create CIs and publish them.

FIG. 11 shows an example of a graphical user interface (GUI) 1100 including various buttons, icons, and features for editing, validating, or testing a software application classifier. The menu includes clickable buttons including “Update,” “Create Components,” “Insert,” “Insert and Stay,” “Publish Not Relevant,” “Save,” “Test Name and Parameters Regex,” “Test With Other Clusters,” “Delete,” and the like.

In some embodiments, the GUI allows a system administrator to modify and edit any of the fields, rules, or tables of a software application classifier. For example, additional descriptions may be added to the fields “Short Description” and “Description (Customer Visible).” System administrators may also use the GUI to modify the grouping rules and conditions, for example, to re-group the software processes based on their preferences or knowledge of the organization's software inventory.

FIG. 12 shows an example of a graphical user interface 1200 including a drop-down menu for modifying one of the rules of the software application classifier. The “Process Name” 1202 may include a rule or definition, and a drop-down menu 1204 is provided to offer a list of options to the system administrator. The title of the field, or the currently-selected item in the list, is displayed. When the visible item is clicked, other items from the list “drop-down” are shown, and the system administrator can choose from those options, including “starts with,” “ends with,” “contains,” “does not contain,” and the like. As shown in drop-down menu 1204, a “matches pattern” or a “matches regex” may be selected. A regex is a regular expression that is sometimes referred to as a rational expression. A regex is a sequence of characters that specifies a match pattern in text. Usually such patterns are used by string-searching algorithms for “find” or “find and replace” operations on strings, or for input validation. Regular expression techniques are developed in theoretical computer science and formal language theory.

In some embodiments, the GUI allows a system administrator to modify and edit any of the fields, rules, or tables of a software application classifier, based on information or suggestions that are generated by a generative artificial intelligence (GenAI) model. For example, the administrators may use the GUI to modify the grouping rules and conditions of the software application classifier to re-group the software processes based on the output of a GenAI model.

FIG. 13 shows an example of a graphical user interface 1300 that provides different categories of suggestions generated by a GenAI model. Each row of the table includes a plurality of suggested items generated by a GenAI model based at least in part on a set of data. The Suggested Publisher entry 1302 in row 1 is “Oracle.” The Suggested Product entry 1304 in row 1 is “Oracle Database.” The Suggested Description entry 1306 is “Oracle Database is a fully managed, scal . . . ” The Suggested G2 entry 1308 is “Database Management Systems.” And the entry 1310 is a set of data that is used by the GenAI model to generate the different suggested items.

The set of data may include the raw metadata associated with the running processes of the plurality of customer companies, organizations, or entities that is uploaded from the plurality of customer databases 202 to shared database 204. The set of data may also include the processed metadata that is generated based on the raw metadata associated with the running processes. For example, the set of data may include the customer-level application fingerprint reports that are uploaded to shared database 204. For example, if a customer classifies N different processes into a single software process grouping, then the application fingerprint report may include an application name and at least some of the metadata associated with the N processes that are classified into this application. The application name associated with the application fingerprint report is a descriptive identifier for the software process grouping.

FIG. 14 shows an example of a graphical user interface 1400 that provides AI suggested Application Fingerprints. GUI 1400 allows the system administrator to discover and add applications from suggestions derived by Predictive Intelligence machine learning. GUI 1400 includes a window 1402 showing the total number of AI suggested application fingerprints. GUI 1400 includes a window 1404 showing the total number of content service suggestions. GUI 1400 includes a window 1406 showing the total number of application CIs discovered. GUI 1400 includes a window 1408 showing the top application CIs discovered, including MS SQL DataBase, Web Service, Microsoft iis Web Server, MySQL instance, and the like.

FIG. 15 shows an example of a graphical user interface 1500 that allows the user to conduct a search within the suggested applications. For example, when the user enters “database” in the search text entry box 1502, a list of database related suggested applications are provided, including “Database as a Service (DBaaS) Provider,” “Database Backup,” “Database Management System (DBMS),” “Document Databases,” and the like. The user may then activate any of the suggested applications by selecting the corresponding check boxes.

FIG. 16 shows an example of a graphical user interface 1600 that displays a plurality of suggested applications. Each application fingerprint suggestion includes a Suggested Group Name, a Discovery Pattern name, a process count, and an accuracy percent.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A method comprising:
obtaining a plurality of reports corresponding to a plurality of candidate applications from a plurality of entities, wherein each report comprises information corresponding to a plurality of software processes associated with one of the plurality of candidate applications and running on one of the plurality of entities;
identifying correlations among the plurality of reports corresponding to the plurality of candidate applications from the plurality of entities;
generating a software application classifier for automatically identifying one or more software processes associated with an application that is used across multiple entities, based at least in part on the identified correlations; and
providing the software application classifier for automatically identifying the one or more software processes associated with the application that is used across multiple entities to at least one of the plurality of entities.

2. The method of claim 1, wherein the information corresponding to the plurality of software processes comprises metadata corresponding to the plurality of software processes.

3. The method of claim 2, wherein the metadata corresponding to the plurality of software processes comprises process names or process parameters for configuring the plurality of software processes.

4. The method of claim 1, wherein one of the plurality of reports corresponding to the plurality of candidate applications is generated by one of the plurality of entities by:
identifying one or more software processes as being associated with one of the plurality of candidate applications using data clustering based on one or more of the following: process parameters, process command lines, or process names.

5. The method of claim 1, comprising:
combining a first report of the plurality of reports from a first entity of the plurality of entities with a second report of the plurality of reports from a second entity to form a combined report corresponding to one of the plurality of candidate applications based on the identified correlations, wherein the one of the plurality of candidate applications comprises a third-party software application.

6. The method of claim 5, further comprising:
generating the software application classifier for automatically identifying the one or more software processes associated with the application that is used across multiple entities based on the combined report.

7. The method of claim 6, further comprising:
initializing at least some of a plurality of fields of the software application classifier for automatically identifying the one or more software processes associated with the application that is used across multiple entities based on the combined report.

8. The method of claim 6, further comprising:
initializing at least some of a plurality of rules of the software application classifier for automatically identifying the one or more software processes associated with the application that is used across multiple entities based on the combined report.

9. The method of claim 6, further comprising:
providing a graphical user interface (GUI) for modifying the software application classifier for automatically identifying the one or more software processes associated with the application that is used across the multiple entities based on outputs of a generative artificial intelligence (GenAI) model, wherein the outputs of the GenAI model are generated based on at least a portion of the plurality of reports corresponding to the plurality of candidate applications.

10. The method of claim 1, wherein identifying a correlation between two of the plurality of reports corresponding to the plurality of candidate applications comprises identifying the two of the plurality of reports corresponding to the plurality of candidate applications as having substantially identical descriptive identifiers.

11. A system comprising:
a processor configured to:
obtain a plurality of reports corresponding to a plurality of candidate applications from a plurality of entities, wherein each report comprises information corresponding to a plurality of software processes associated with one of the plurality of candidate applications and running on one of the plurality of entities;
identify correlations among the plurality of reports corresponding to the plurality of candidate applications from the plurality of entities;
generate a software application classifier for automatically identifying one or more software processes associated with an application that is used across multiple entities, based at least in part on the identified correlations; and
provide the software application classifier for automatically identifying the one or more software processes associated with the application that is used across multiple entities to at least one of the plurality of entities; and
a memory coupled to the processor and configured to provide the processor with instructions.

12. The system of claim 11, wherein the information corresponding to the plurality of software processes comprises metadata corresponding to the plurality of software processes.

13. The system of claim 12, wherein the metadata corresponding to the plurality of software processes comprises process names or process parameters for configuring the plurality of software processes.

14. The system of claim 11, wherein one of the plurality of reports corresponding to the plurality of candidate applications is generated by one of the plurality of entities by:
identifying one or more software processes as being associated with one of the plurality of candidate applications using data clustering based on one or more of the following: process parameters, process command lines, or process names.

15. The system of claim 11, wherein the processor is further configured to:
combine a first report of the plurality of reports from a first entity of the plurality of entities with a second report of the plurality of reports from a second entity to form a combined report corresponding to one of the plurality of candidate applications based on the identified correlations, wherein the one of the plurality of candidate applications comprises a third-party software application.

16. The system of claim 15, wherein the processor is further configured to:
generate the software application classifier for automatically identifying the one or more software processes associated with the application that is used across multiple entities based on the combined report.

17. The system of claim 16, wherein the processor is further configured to:
initialize at least some of a plurality of fields of the software application classifier for automatically identifying the one or more software processes associated with the application that is used across multiple entities based on the combined report.

18. The system of claim 16, wherein the processor is further configured to:
initialize at least some of a plurality of rules of the software application classifier for automatically identifying the one or more software processes associated with the application that is used across multiple entities based on the combined report.

19. The system of claim 16, wherein the processor is further configured to:
provide a graphical user interface (GUI) for modifying the software application classifier for automatically identifying the one or more software processes associated with the application that is used across the multiple entities based on outputs of a generative artificial intelligence (GenAI) model, wherein the outputs of the GenAI model are generated based on at least a portion of the plurality of reports corresponding to the plurality of candidate applications.

20. A computer program product embodied in a non-transitory computer readable medium and comprising computer instructions for:
obtaining a plurality of reports corresponding to a plurality of candidate applications from a plurality of entities, wherein each report comprises information corresponding to a plurality of software processes associated with one of the plurality of candidate applications and running on one of the plurality of entities;
identifying correlations among the plurality of reports corresponding to the plurality of candidate applications from the plurality of entities;
generating a software application classifier for automatically identifying one or more software processes associated with an application that is used across multiple entities, based at least in part on the identified correlations; and
providing the software application classifier for automatically identifying the one or more software processes associated with the application that is used across multiple entities to at least one of the plurality of entities.
